(19) United States
(12) Patent Application Publication
(10) Pub. No.: US 2010/0052282 A1
(43) Pub. Date: Mar. 4, 2010

(54) STABILIZER DEVICE WITH WHEELED GUIDE ARM

(75) Inventors: Benjamin Baumer, Ibbenburen (DE); Peter Hofmann, Gauting (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/515,468

(22) PCT Filed: Oct. 25, 2007
(86) PCT No.: PCT/DE07/01911

§ 371 Date: May 19, 2009

(30) Foreign Application Priority Data
Nov. 20, 2006 (DE) 10 2006 054 874.4

(51) Int. Cl. B60G 7/02; B60G 21/055

(52) U.S. Cl. 280/124.107; 280/124.152

(57) ABSTRACT

An anti-roll bar device of an axle of a motor vehicle. The axle has an anti-roll bar (2) and, for each wheel, at least one steering rod (1). The chassis articulation (6) of the steering rod (1) is connected with an end (3) of the anti-roll bar (2), while the compensation movement of the steering rod (1) causes a twisting actuation of the (1) anti-roll bar (2). The anti-roll bar device is distinguished by the fact that the anti-roll bar (2) is rigidly connected with the chassis side end of the steering rod (1). The anti-roll bar arrangement facilitates constructively simple and sturdy articulation of the steering rod directly on the anti-roll bar as well as on the vehicle chassis or the axle mount. Furthermore, the assembly and installation of the anti-roll bar is simplified and the required structural space, weight and cost of the anti-roll bar are improved.

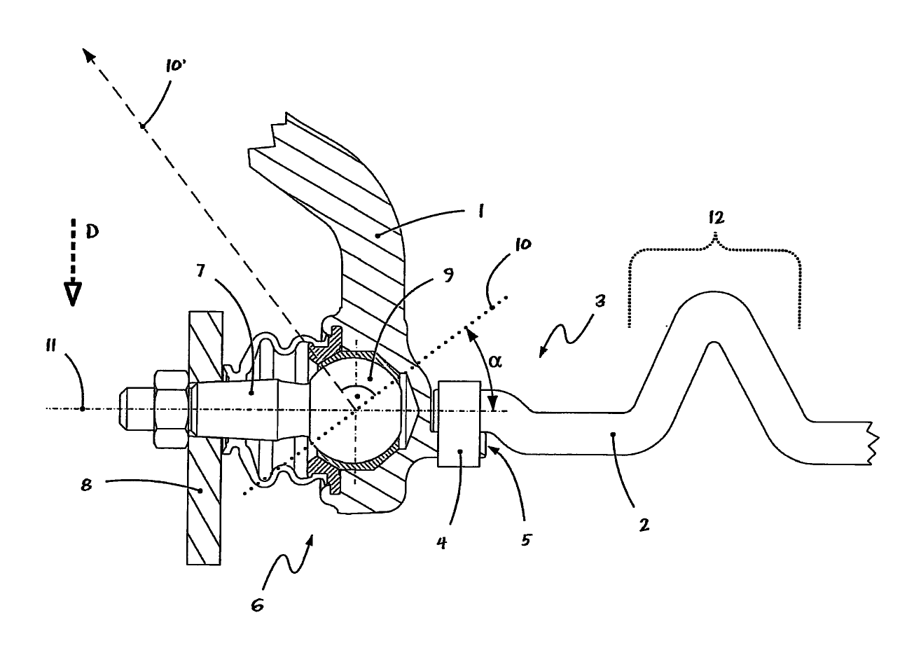

This application is a National Stage completion of PCT/DE2007/001911 filed Oct. 25, 2007, which claims priority from German patent application serial no. 10 2006 054 874.4 filed Nov. 20, 2006.

### FIELD OF THE INVENTION

This invention relates to a stabilizer device for a vehicle axle with a roll stabilizer.

### BACKGROUND OF THE INVENTION

Typical vehicle axles, where the roll stabilizer is actuated directly by a wheel guide steering rod connected with the roll stabilizer, for example, by a hinged tie bar or diagonal strut of the wheel suspension, are first of all advantageous inasmuch as one can thus achieve a stabilizer ratio of 1:1. In other words, this means that the wheel's compression movements—in contrast to what happens in the case of the traditional roll stabilizers with pendulum support articulation—are converted into a corresponding torsion movement of the stabilizer not only proportionately but also in each case to the full extent. In such directly actuated stabilizer devices, one can therefore use, for example, correspondingly thinner and thus lighter stabilizers.

This design, moreover, makes it possible to eliminate the direct connection of the stabilizer on the wheel guide steering rod as well as the usual articulations of the stabilizer ends via their own pendulum supports with in each case two ball-and-socket joints and likewise the usual angled stabilizer legs, which also results in a weight saving, thus making additional valuable structural space available in the area of the wheel suspension.

Such typical stabilizer devices are known, for example, from DE 10 2004 020 073 A1 or from EP 1 564 041 A2. In these known stabilizer devices, a wheel guide steering rod, constructed as hinged tie bar and belonging to a wheel suspension, is connected with its chassis side end directly upon an end of the roll stabilizer. In this way, one can achieve a stabilizer ratio of 1:1 and one can do without the usual expensive, separate articulation of the stabilizer by means of hinged supports.

The connection type of the chassis side end of the wheel guide steering rod to the stabilizer end in these known stabilizer devices, however, is comparatively expensive. Besides, in the case of the stabilizer devices known from the state of the art, the wheel guide forces, transmitted via the wheel guide steering rod, are introduced into the axle mount or into the vehicle chassis via the stabilizer as well as via the stabilizer bearings. Since first of all the stabilizer and the stabilizer bearing are not designed for the absorption and feeding of wheel guide forces into the vehicle chassis, it is necessary to enter into considerable compromises in the solutions known from the state of the art with relation to force introduction and vibration absorption.

There is another fact that makes it more difficult to couple the wheel guide steering rod to the stabilizer end; the rotation axis of the stabilizer extends in direction transversal to that of the vehicle, while the rotation axes of wheel guide steering rods, for example, the rotation axes of the hinged tie bars or diagonal struts considered here, generally extend at an acute angle with respect to the direction transversal to the vehicle. If the event of direct articulation of chassis-side end of a wheel guide steering rod on the roll stabilizer, then the rotation axis of the wheel guide steering rod that extends at an acute angle with respect to the transversal axis of the vehicle must thus be converted to the rotational axis that extends in the direction of the transversal direction of the vehicle, owing which considerable constructional expenditure arises in the area of the connection of the wheel guide steering rod and roll stabilizer in connection with the state of the art.

Against this background, it is the object of this invention to provide a wheel-guiding stabilizer device with which the disadvantages inherent in the state of the art can be overcome. In this case, the stabilizer device should in particular make possible a simple and simultaneously robust articulation of the chassis-side end of the wheel guide steering rod upon the roll stabilizer and upon the chassis as well as the axle mount. Compared to the state of the art, furthermore, improvements are to be introduced regarding the structural space required by the stabilizer device as well as simplifications in stabilizer and axle assembly.

### SUMMARY OF THE INVENTION

First considered by itself in a familiar manner, the anti-roll bar device according to the invention is intended for use on a vehicle axle with anti-roll bar, whereby the axle for each wheel has at least one wheel steering rod. Here in a first of all likewise known manner, the chassis-side articulation of the wheel steering rod is so connected with the associated terminal area of the anti-roll bar that the compression movements of the wheel steering rod will directly result in a twisting actuation of the anti-roll bar.

The anti-roll bar device is distinguished by the fact that the anti-roll bar is rigidly connected with the chassis-side end area of the wheel steering rod.

A rigid connection of the end of the anti-roll bar with the end of the steering rod—thus managing without joints—is first of all advantageous in this connection inasmuch as the constructionally expensive and typically susceptible, articulated connection of the wheel steering rod upon the end of the anti-roll bar is completely dispensed with. Besides, in this way, one can make possible a direct conversion completely free of play of the stroke motion of the control arm into a corresponding rotary motion of the anti-roll bar, with which the desirable immediate response of the anti-roll bar also improves.

Compared to the traditional connection of the anti-roll bar via hinged supports, this arrangement furthermore offers the advantage that one can eliminate both the hinged supports and their comparatively expensive assembly, while furthermore, instead of separate bearings for the anti-roll bar and the chassis side end of the wheel steering rod, one needs only a common bearing for the control arm and the anti-roll bar for each side of the vehicle. Moreover, one can eliminate the bent ends of the anti-roll bar, which simplifies the production of the stabilizer and reduces its mass.

Beyond this, even further advantages will be attained which, in particular, concern the simple, uncomplicated assembly of the anti-roll bar upon the vehicle and corresponding cost savings.

This is also especially based on the realization that (due to the fact that the rotational axes of the wheel steering rod and the anti-roll bar are not parallel, but rather extend at an acute angle with respect to each other) in the case of a rigid connection of the wheel steering rod and the anti-roll bar, any induced bending of the anti-roll bar will turn out to be comparatively minor, and can thus be readily absorbed by most of the stabilizer configurations.

Due to the bending of the anti-roll bar in the transversal direction of the vehicle, which is connected with the stroke movement of the wheel steering rod, this arrangement is particularly suitable—although by no means exclusively so—for use with thinner anti-roll bars such as they are used, for example, in lighter vehicles or on the rear axles of vehicles.

According to the invention, the chassis-side articulation of the wheel steering rod is made in the form of a ball-and-socket joint. This results in an improved absorption of the secondary torque and forces generated by the bending of the anti-roll bar as well as a direct transmission of the compression movements of the wheel steering rod upon the anti-roll bar and thus also upon the wheel steering rod of the opposite side of the vehicle.

By using a ball-and-socket joint in place of an elastomer bearing to tie the wheel guide rod to the vehicle chassis, one, of course, initially increases the overall stiffness of the system consisting of the wheel steering rod and the two bearing points of the wheel steering rod. The overall stiffness of the wheel steering rod, however, can again be adjusted as desired by correspondingly reshaping the hinge point of the wheel steering rod on the wheel side. Thanks to the considerably softer adjustment of the elastomer bearing of the wheel steering rod on the wheel side made possible therewith, it is possible to achieve a quieter coupling, in addition one can save expenses because, a soft rubber pipe can be used for the hinge point on the wheel side (as is also provided according to yet another embodiment of the invention), in particular, without an intermediate pipe.

According to another particularly preferred embodiment of the invention, it is provided that the ball pivot of the ball-and-socket joint with which the wheel steering rod is connected on the chassis side is arranged on the side of the chassis-side end of the wheel guide steering rod that faces toward the wheel. In this way, there results a particularly simple and direct—as well as essentially linear connection—of the anti-roll bar upon the chassis side end of the wheel steering rod because, in this embodiment, one can arrange the ball pivot and the anti-roll bar end on diametrically opposite sides of the ball-and-socket joint.

According to another embodiment of the invention, it is provided that the joint housing of the ball-and-socket joint is formed by the wheel steering rod itself. This embodiment leads to a particularly compact, space-saving and weight-saving configuration possibility for the wheel steering rod, bringing high distortion resistance along with it.

According to another alternate embodiment of the invention, it is provided that the joint housing of the ball-and-socket joint is pressed into the wheel steering rod. This embodiment is particularly suited for constructed wheel steering rods, for example, for wheel guide steering rods that consist of deep-drawing sheet metal parts. Against this background, it is provided according to another likewise preferred embodiment of the invention that the front of the joint housing be flanged toward the outside and/or toward the inside on the ball-joint side.

The outward flanging first of all results in a simple, and secure attachment free of play of the joint housing, especially when one uses constructed or deep-drawn wheel steering rods. On the other hand, one can employ a simultaneous flanging of the ball-joint front of the joint housing by way of an advantageous double function, both to attach the joint housing in the steering rod arm and to fix the ball-joint joint housing lid as well as the sealing bellows on the joint housing.

The invention is first of all implemented regardless of how the rigid connection of the anti-roll bar with the chassis side end of the wheel steering rod is designed so long as the torques and the forces to be transmitted can be absorbed by the connection between the wheel steering rod and the anti-roll bar.

According to a particularly preferred embodiment of the invention the rigid connection between the end of the anti-roll bar and the chassis side end of the wheel steering rod is made in the form of essentially prismatic connecting areas of the anti-roll bar and the wheel steering rod. This embodiment is advantageous in that one can readily balance length tolerances of the stabilizer—as well as the effects of other tolerance chains between the left and right sides of the vehicle—by correspondingly shifting the mutually complementary-shaped prismatic connection areas between the anti-roll bar and the wheel steering rod during the assembly of the anti-roll bar.

The connection between the anti-roll bar and the chassis side end of the wheel steering rod here comprises, for example, an essentially ring-shaped connecting clamp, whereby the connecting clamp embraces the complementary-shaped connecting areas in an annular fashion between the anti-roll bar and the wheel steering rod and presses them upon each other. Preferably, the connecting clamp is constructed as a screw clamp by means of which the two connecting areas between the anti-roll bar and the wheel steering rod can be pressed against each other by means of a threaded screw connection contained in the connecting clamp. That especially further simplifies the assembly of the anti-roll bar.

According to another preferred embodiment of the invention, the anti-roll bar has at least one essentially S-shaped compensation area. With the help of the compensation area arranged in the anti-roll bar one can prevent torque biases between the wheel suspensions on the left and on the right sides of the vehicle because the bendings and the attendant effective length changes of the anti-roll bar that occur during the compression of the wheel steering rod that is rigidly connected with the anti-roll bar can be absorbed and rendered harmless by the compensation area.

According to a particularly preferred embodiment of the invention, it is finally provided that the wheel steering rod is a hinged tie bar or a diagonal strut of a wheel suspension. Although the invention is basically used in conjunction with the various control arm shapes, such as transversal control arms, oblique control arms, or longitudinal control arms, the use of the invention in conjunction with a hinged tie bar or with a diagonal strut is particularly advantageous inasmuch as, when working with a tension or diagonal strut, the acute angle between the swing axis of the strut and the rotation axis of the anti-roll bar is particularly small. That results in a particularly reduced bending as well as direct transmission of the anti-roll bar during the compensation movement of the wheel steering rod. Furthermore, in this embodiment of the invention, the anti-roll bar can be arranged without any structural space problems in a particular space-saving manner in the particular forward or rear area of the axle mount in which the traction or diagonal strut is also articulated.

### BRIEF DESCRIPTION OF THE DRAWING

The invention will be explained in greater detail below with reference to merely one drawing illustrating an embodiment, wherein

The FIGURE shows an embodiment in schematic representation of the connection between the wheel steering rod and the stabilizer end of an anti-roll bar device viewed from below according to the invention.

### DETAILED DESCRIPTION OF THE PREFERRED EMBODIMENTS

The FIGURE shows the connection between a wheel steering rod 1 and the pertinent end 3 of an anti-roll bar 2 in an embodiment of a anti-roll bar device according to this invention, looking at it from the underside of the vehicle. The FIGURE illustrates the left end of the anti-roll bar with relation to the direction of movement as well as chassis side end of the pertinent wheel steering rod 1 of the left wheel. The direction of motion of the associated vehicle here, with relation to the drawing, is downward, as indicated by the broken line of arrow D.

In the FIGURE, we first of all recognize the vehicle-related left end area 3 of the massively shaped anti-roll bar 3 of the vehicle; as well as the chassis side end area of a likewise only partly illustrated wheel steering rod 1, which actually involves a hinged tie bar of the wheel suspension of one of the left wheels of a motor vehicle.

The end 3 of anti-roll bar 1, illustrated in the FIGURE, is rigidly connected here by means of a connecting clamp 4 that is pressed or mounted by means of a (not illustrated) threaded screw connection and in a rotationally fixed manner with a connection extension 5 that is integrally molded upon the end area of the wheel steering rod 1.

The articulation of the wheel steering rod 1 on the chassis side is present in the form of a ball-and-socket joint 6. Here, the chassis side end of the wheel steering rod 1 simultaneously forms the joint housing of the ball-and-socket joint, while the ball pivot 7 of the ball-and-socket joint 6 is connected with the vehicle chassis, or with an axle mount 8 (not shown).

Connection line 10′, running through the center of the ball joint 9 according to the FIGURE, points with the tip of its arrow in the direction of the wheel articulation point of the wheel steering rod 1 upon which is connected the wheel steering rod 1 with the (not shown for reasons of space) wheel bracket of the pertinent vehicle wheel.

This means that a wheel steering rod 1 during the compression movements of the pertinent wheel (in its position illustrated according to the FIGURE) will swing around the rotation axis 10 shown by the dotted line. In that way, rotational axis 10 of the wheel steering rod 1 will not agree with the rotational axis 11 of the anti-roll bar 2 that is determined by the ball-and-socket joint 6 (and the latter's counterpart on the other vehicle side). Instead, the rotational axes 10 and 11 of the wheel steering rod 1 and the anti-roll bar 2 will form the acute angle a. This is why the anti-roll bar 2 during the compression movements of the wheel steering rod 1 will no longer be swung around its own rotational axis 11 or twisted around it, but rather additionally experiences further bending that runs contrary to the direction of the compression movement of the wheel steering rod 1.

In other words, the anti-roll bar 2 is bent further downward with relation to the vehicle, if the compression of a wheel of the motor vehicle is directed inward—in other words, upward with relation to the vehicle. But it was found that this bending of the anti-roll bar lies in the area of smaller angle degrees and, on top of that, it is practically negligible form the viewpoint of the attendant bending stress on the anti-roll bar. Any effective length changes of the anti-roll bar 2 connected with the bending of anti-roll bar 2—in other words, any changes of the interval between the ends of the anti-roll bar 3—are furthermore neutralized on the anti-roll bar 2 by the stress-relief arc 12 so that, because of the bending of the anti-roll bar, there cannot be any major strains between the left and the right wheel suspension.

Compared to the state of the art, where the actuation of the anti-roll bar takes place directly by a wheel steering rod that is flexibly connected with the anti-roll var, thanks to the invention-based connection between the end of the anti-roll bar 3 and the chassis side end of wheel steering rod, there arises a very considerable simplification of the design of the axle structure with the corresponding advantageous consequences in terms of simpler assembly and cost savings.

Compared to the usual articulation of the anti-roll bar via hinged supports, the invention offers additional considerable advantages in terms of the elimination of the hinged supports and their assembly and furthermore by the elimination both of the chassis elastomer bearing of the wheel steering rod and by virtue of the elimination of additional bearings of the anti-roll bar in the form of the softer and more cheaply made elastomer bearings of the wheel steering rod on the wheel side as well as finally in the form of the anti-roll bar that can be made shorter with a simpler shape and thus lighter and more cheaply.

This finally makes it clear that, as a result of the invention, an anti-roll bar device is created that, compared to the state of the art, offers critical advantages in terms of a simplified and operationally robust articulation of the wheel steering rod upon the anti-roll bar as well as on the vehicle chassis. Compared to the state of the art, improvements regarding the required structural space as well as simplifications during the assembly of the anti-roll bar and the axle can therewith be achieved.

The invention thus makes a critical contribution to the improved design as well as cost savings during the production and assembly of wheel control anti-roll bar devices, especially for use on axle systems that are very demanding in terms of driving dynamics.

### REFERENCE NUMBER LIST

1 Wheel steering rod, hinged tie bar
2 Anti-roll bar
3 Stabilizer end
4 Connecting clamp
5 Connecting extension
6 Ball-and-socket joint
7 Ball pivot
8 Axle mount
9 Ball joint
10 Rotational axis
10′ Connection line
11 Rotational axis
D Direction of travel

1-12. (canceled)

13. A stabilizer device for a motor vehicle axle, the stabilizer device comprising:
an anti-roll bar (2), and
for each wheel, at least one wheel steering rod (1),
a chassis articulation (6) of the wheel steering rod (1) being connected with a terminal area (2) of the anti-roll bar (2) such that compression movement causes a twisting actuation of the anti-roll bar (2),
the anti-roll bar (2) being rigidly connected with a chassis side end of the wheel steering rod (1), and
the chassis articulation of the wheel steering rod (1) is ball-and-socket joint (6).

14. The stabilizer device according to claim 13, wherein a wheel articulation of the wheel steering rod (1) is a rubber bearing without an intermediate pipe.

15. The stabilizer device according to claim 13, wherein a ball pivot (7), of the ball-and-socket joint (6), is arranged on a side of the wheel steering rod (1 ) that faces toward the wheel.

16. The stabilizer device according to claim 13, wherein a joint housing, of the ball-and-socket joint (6), is formed by the wheel steering rod (1).

17. The stabilizer device according to claim 13, wherein a joint housing, of the ball-and-socket joint (6), is pressed into the wheel steering rod (1).

18. The stabilizer device according to claim 17, wherein a front of the joint housing is flanged outward on a side of the ball pivot.

19. The stabilizer device according to claim 17, wherein the front of the joint housing is flanged inward on a side of the ball pin.

20. The stabilizer device according to claim 13, wherein the rigid connection of the anti-roll bar (2) with the chassis side end of the wheel steering rod (1) is in a shape of essentially prismatic connection areas (5) of the anti-roll bar (2) and the wheel steering rod (1).

21. The stabilizer device according to claim 20, wherein the connection of the anti-roll bar (2) with the chassis side end area of the wheel steering rod (1) comprises an essentially ring-shaped connecting clamp (4) that clasps around an extension area (5) of the anti-roll bar (2) and the wheel steering rod (1).

22. The stabilizer device according to claim 21, wherein the connecting clamp (4) is a screw clamp.

23. The stabilizer device according to claim 13, wherein the anti-roll bar (2) has at least one longitudinal compensation area formed substantially in an S-shape (12).

24. The stabilizer device according to claim 13, wherein the wheel steering rod (1) is one of a traction strut or a diagonal strut of a wheel suspension.

25. A stabilizer device for a motor vehicle axle, the device comprising:
an anti-roll bar (2) having an S-shaped resiliently flexible section (12) adjacent to at least one end (3) of the anti-roll bar (2) for absorbing compression forces along the length of the anti-roll bar (2);
a steering rod (1) having an end with a socket into which a ball stud (7) is secured to form a ball and socket joint (6), and the ball stud (7) being coupled to an axle carrier (8); and
the end (3) of the anti-roll bar (2) being rigidly fixed to an extension (5) of the steering rod (1) by an annular clamp (4).
